(19) United States
(12) Patent Application Publication
(10) Pub. No.: US 2014/0374191 A1
(43) Pub. Date: Dec. 25, 2014

(54) CRANE BOOM ACCESS

(71) Applicant: CONOCOPHILLIPS COMPANY, Houston, TX (US)

(72) Inventor: Laurie Forbes MACKAY, Alford (GB)

(73) Assignee: CONOCOPHILLIPS COMPANY, Houston, TX (US)

(21) Appl. No.: 14/281,244

(22) Filed: May 19, 2014

Related U.S. Application Data
(60) Provisional application No. 61/836,970, filed on Jun. 19, 2013.

(51) Int. Cl. B66C 13/00; B66C 23/62

(52) U.S. Cl. CPC B66C 13/00; B66C 23/62
USPC 182/36; 212/271

(57) ABSTRACT

Methods and apparatus access the boom (jib) of a crane, e.g. of the type commonly employed on offshore oil rigs. In place of the extensive scaffolding structure normally required to provide secure access to a crane boom (10) for maintenance and inspection, a carriage (11) is mounted on the boom either on a temporary or permanent basis. The carriage (11) includes a stable platform (22) or floor capable of supporting one or preferably two workers (23) to provide comfortable and safe access to the boom for e.g. a re-painting operation. The carriage (11) is supported on the boom via wheels (16) and is movable along the boom to provide access to the full length of the boom. The distal end may be of tapering section and it is preferred that the wheels (16) of the carriage are adjustably mounted to take account of the taper.

### CROSS-REFERENCE TO RELATED APPLICATIONS

This application is a non-provisional application which claims benefit under 35 USC §119(e) of and priority to U.S. Provisional Application Ser. No. 61/836,970 filed 19 Jun. 2013, entitled “CRANE BOOM ACCESS,” which is incorporated by reference herein in its entirety.

### STATEMENT REGARDING FEDERALLY SPONSORED RESEARCH OR DEVELOPMENT

None.

### FIELD OF THE INVENTION

This invention relates to apparatus and methods for accessing crane booms or jibs, e.g. for the purposes of inspection or maintenance or repair work.

### BACKGROUND OF THE INVENTION

Many cranes in use, e.g., on oil and gas platforms comprise a pedestal on which is mounted a cab. On top of the cab is an A frame and, extending from the front of the cab is a boom. The cab rotates on the platform and the boom is pivotally mounted to the front of the cab so that it can be raised and lowered by means of a cable leading from the distal end of the boom and passing around a pulley at the top of the A frame. A lifting cable extends from a winch located in or on the pedestal or cab, along the boom to a pulley at the distal end of the boom.

As with all plant and equipment, inspection and maintenance needs to be carried out on the crane. This is normally done by erecting scaffolding. A relatively small quantity of scaffolding is required to access the tower, cab and A frame, or alternatively access can be by rope. However, access to the boom requires a lot of scaffolding because the boom extends over a much larger footprint that the pedestal etc. Erecting scaffolding can be time consuming and expensive, especially if it has to be specially shipped out to an offshore oil or gas platform.

An alternative method of accessing the boom is to walk out along or inside it, clipped onto the structure with an appropriately equipped harness. This is a slightly hazardous operation and the lack of a stable platform makes anything other than a brief inspection awkward and tiring.

### BRIEF SUMMARY OF THE DISCLOSURE

In one embodiment of the invention, a method of accessing the boom of a crane comprises: a) mounting on the boom a wheeled carriage having a solid platform which is capable of supporting the weight of at least one person standing on the platform; and b) moving the carriage along the boom to provide access to different parts of the boom.

The invention can be used with cranes having a boom (sometimes called a “jib”) which can pivot in a horizontal plane but is unable to pivot vertically, i.e. the main axis of the boom/jib is fixed in a horizontal orientation. However, the invention is particularly applicable to cranes of the type which comprise a boom or jib which is hinged at its proximal end to allow it to swivel in a vertical plane (pivoting about a horizontal pivot axis), but which is capable of being placed in a horizontal or substantially horizontal (i.e. within 10 degrees of horizontal) position. Such cranes are commonly used in the oil and gas industry on offshore rigs but also in many other situations. Normally, such a crane would not have a travelling trolley mounted on the boom.

In one embodiment of the invention, the carriage with solid platform is mounted on the boom before maintenance work is carried out, and then removed afterwards. Alternatively, the carriage with solid platform may be permanently mounted to the boom.

In either case, the carriage may be supported on the boom via wheels. The position of the wheels on the carriage may be adjusted to accommodate variations in the shape of the boom and/or appurtenances on the boom, as the carriage moves along the boom.

The carriage may comprise a framework adapted to be assembled into a box configuration with open ends; the carriage may be assembled to the boom such that the framework extends adjacent top, bottom and side faces of the boom.

In another embodiment, the invention envisages a crane having a boom fitted with a movable carriage, wherein the carriage comprises a solid platform for bearing the weight of at least one person to allow access to the boom. The carriage may be fitted with wheels which engage with the boom and whose position is adjustable to accommodate changes in the geometry of the boom and/or appurtenances on the boom, as the carriage moves along the boom. The carriage may comprise a framework extending adjacent top, bottom and side faces of the boom.

In another embodiment, the invention envisages a carriage for permitting access to a crane boom, the carriage comprising a framework capable of being assembled into a box configuration with open ends, the carriage further comprising:
a) wheels internal of the box framework for engaging with the crane boom;
b) a solid platform for supporting at least one person.

### BRIEF DESCRIPTION OF THE DRAWINGS

A more complete understanding of the present invention and benefits thereof may be acquired by referring to the follow description taken in conjunction with the accompanying drawings in which:

FIG. 1 is a schematic view of a crane suitable for fitting with a maintenance access carriage according to the invention (prior art);

FIG. 2 is a side elevation of a crane boom with an access carriage in accordance with the invention mounted on it;

FIG. 3 is a cross section on an enlarged scale through the region marked “A” in FIG. 2;

FIG. 4 is a perspective view of one side or top panel of the carriage of FIGS. 2 and 3

FIG. 5 is a perspective view on an enlarged scale and partly cut away of the region marked “A” in FIG. 2; and

FIG. 6 is a detailed view of the access carriage showing the carriage mounted at the distal end of the boom where the cross section of the boom tapers (marked “B” in FIG. 2).

FIG. 6a is a detail from FIG. 6 showing wheels mounted on the carriage.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

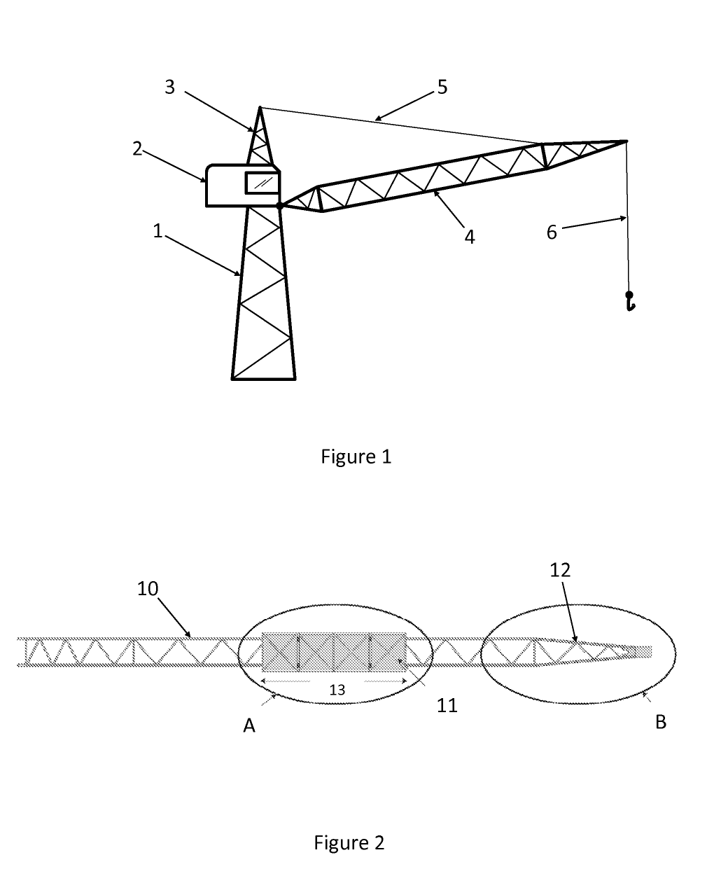

FIG. 1 shows, in highly schematic form, a conventional crane of op of a type suitable for use with an access carriage according to the invention. The crane comprises a pedestal 1 on which is mounted a cab 2. On top of the cab 2 is an A frame 3 and, mounted in front of the cab and able to pivot about a horizontal axis is a crane boom (or jib) 4. The boom is retained by means of a cable stay 5 extending from the top of the A frame 3 to a point along the length of the boom 4. The cab 2, A frame 3 and boom 4 are mounted (by means not shown) to rotate about a vertical axis with respect to the pedestal. A hoisting cable 6 runs from a winch (not shown), along the boom 5 and around a pulley (not shown) at the distal end of the boom 4. The position of the distal end of the crane can be adjusted by rotating the cab/A frame/boom assembly and also by lifting or lowering the boom by winching in or out the cable stay 5.

FIG. 2 shows a crane boom 10 from a crane of the type shown in FIG. 1 with an access carriage 11 according to the invention mounted on the boom 10. For the majority of its length the boom 10 has a constant cross section, but at the distal end of the boom is a section 12 in which the cross section tapers.

The approximate length 13 of the carriage is 4 to 5 meters, whilst the width 14 and height 15 are approximately 3.5 meters. These dimensions are of course tailored to the particular design of crane for which the carriage is intended, and have no particular significance for the invention, other than that the carriage should be large enough to allow for the convenient use of at least one person.

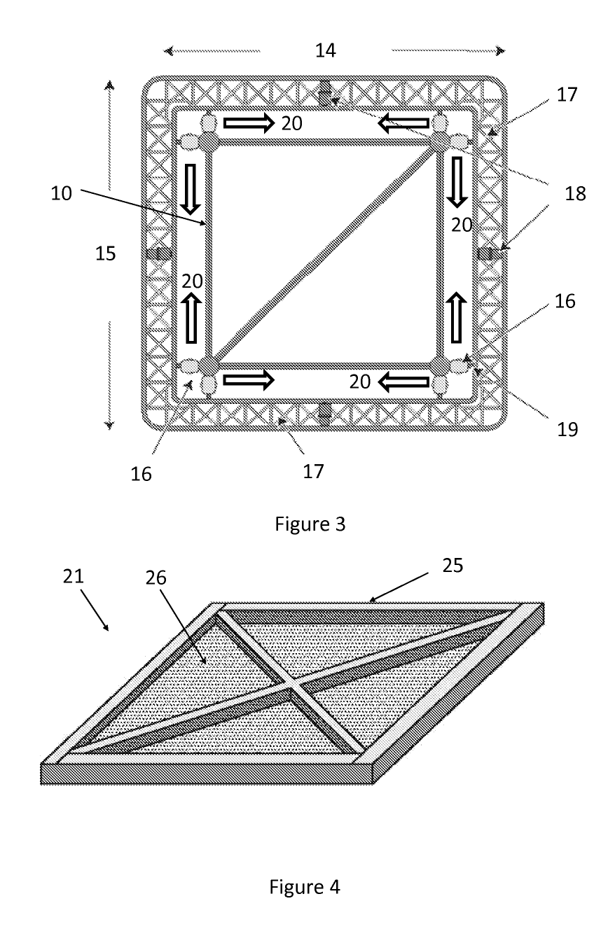

The carriage 11, as can be seen from FIG. 3, comprises a box section whose base, top and sides are constructed of a lattice framework 17. The material is a lightweight, e.g. aluminum-based, alloy. Mounted on the interior of the framework are a number of rollers 16 which engage with the boom 10 in order to retain the carriage 11 in place and to allow it to move along the length of the boom 10. In the center of each face of the carriage, the face is divided. A number of hydraulic actuators 18 at each divide are provided to allow for part of the frame to be moved away from the remainder of the framework in order to allow the carriage to pass over appurtenances on the boom.

There are a number of ways in which the framework may be separated. A corner portion of the framework may be moved away—in a diagonal direction in FIG. 3—taking the rollers 16 on that part of the frame with it. In this event the remainder of the framework and rollers will adequately retain the carriage in place.

In a more complex but preferred embodiment, the rollers are mounted on the framework by means of adjustable mountings 19 which are capable of supporting the roller 16 at a varying distance from the framework (e.g. by a telescoping pneumatic actuator, not shown in the drawings) and which are also movable on the framework in a direction transverse to the main axis of the carriage as shown by arrows 20 in FIG. 3. Transverse movement can also be controlled by, e.g., pneumatic actuators (not shown in the drawings). Movement of the rollers in this way allows for a full half of the frame to be moved away from the boom to allow the carriage to move past appurtenances on the boom. Moving the frame in this way allows for easier access to the exterior surfaces of the boom for inspection and maintenance work. It also allows for the carriage to be supported on a tapering section of boom as discussed below.

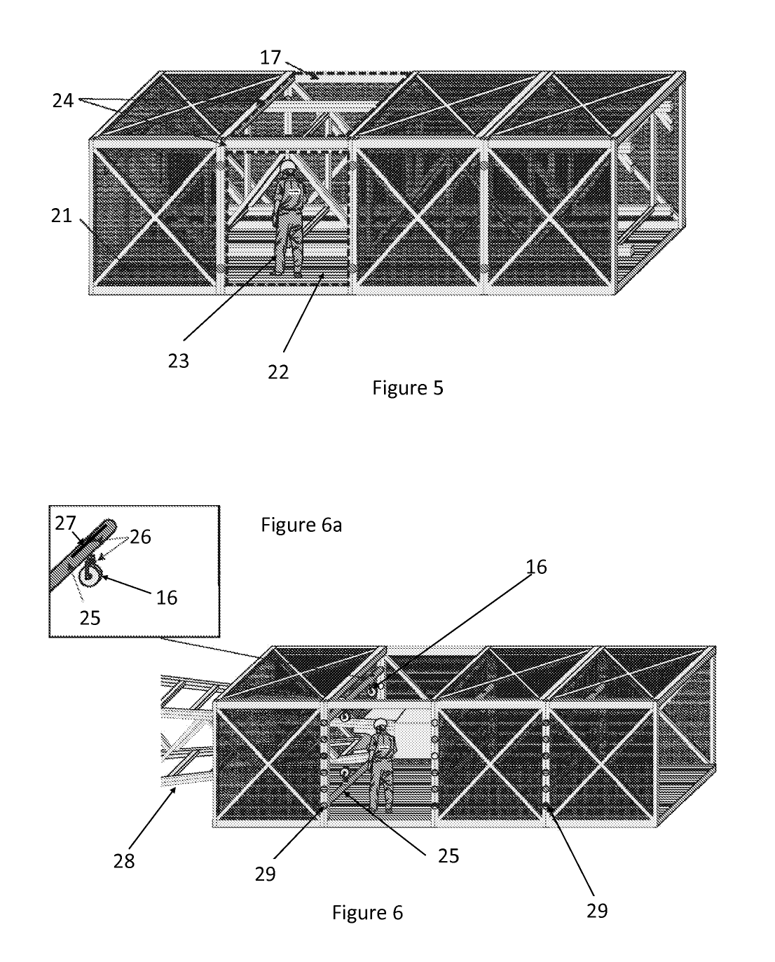

Referring now to FIGS. 4 and 5, the framework 17 is enclosed by removable panels 21 (detailed in FIG. 4) on the sides and top, which provide a worker with a degree of weather protection. The panels 21 comprise an aluminum frame 25 covered with tough weatherproof fabric or plastics sheeting 26. The framework 17 has rebated edges 24 which allow for the panels 21 to be fitted flush with the exterior surface. The floor 22 of the carriage is provided by heavy duty glass reinforced plastic panels, or any other suitable alternative. These may be perforated and either lashed down or fixed in place with studs.

FIG. 5 shows the carriage in place on a section of boom 10 with a constant cross section. A worker 23 is shown standing comfortably on the floor 22 inside the carriage with full access to the boom. It is preferred that the platform 22 is capable of comfortably accommodating at least two workers.

The frame 17 and panels 21 and floor 22 may easily be assembled and disassembled for convenient storage on e.g an offshore oil rig. When required, the carriage may be hoisted up to the boom in pieces and assembled by one or two workers who would be positioned on the boom and clipped to it via safety harnesses. It is likely to be only a few hours' work to assemble the carriage, which may then be used to allow convenient and safe access for a long job such as re-painting the boom or performing a detailed maintenance check.

Alternatively, a carriage may be permanently mounted on a crane boom for convenient use whenever necessary.

The carriage may be moved along the boom e.g. by a cable and winch arrangement, or alternatively the rollers may be powered pneumatically or otherwise. Once the carriage is in the desired position on the boom, a clamp or brake may be engaged to ensure there is no accidental movement of the carriage.

Referring to FIG. 6, a carriage can be seen mounted on a tapering part 28 of a crane boom, in fact at the extreme distal end of the boom. A system for the adjustable mounting of carriage wheels 16 is shown in part. Wheels 16 for engaging with the boom in an upward or downward direction are shown mounted on transverse support bars 25 which are received in mounting apertures 29 in the vertical members of the frame 17.

Referring to the inset FIG. 6a, the wheels 16 are mounted on telescopically extending rods (not shown) passing through a slot 27 in each end of the support bar 25. Locking nuts 26 secure the wheel in the desired position in the slot and also act to lock the telescoping extension of the rods. In this elementary embodiment, the position of the wheels is adjusted manually.

A similar arrangement of wheels supporting the carriage on the boom in a transverse direction would be provided, with vertical support bars mounted on transverse members (not shown) of the frame 17 extending across the top and bottom of the box section at positions in between those of the vertical members which support the horizontal support bars 25. The vertical bars and additional transverse frame members have been omitted from FIG. 6 for clarity.

At least three pairs of vertical support bars and at least three sets of transverse support bars are provided. As the carriage is advanced from a parallel part of the boom to a tapering part, the leading sets of wheels will come out of contact with the boom, but the carriage will be retained in place by the other wheels which are still in engagement with the parallel section of boom, allowing the leading wheels to be adjusted manually to accommodate the taper.

An automatic, pneumatic or electrical powered wheel/support bar adjustment system is to be preferred but for clarity has not been illustrated here.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application.

1. A method of accessing the boom of a crane comprising:
a) mounting on the boom a wheeled carriage having a solid platform which is capable of supporting the weight of at least one person standing on the platform;
b) moving the carriage along the boom to provide access to different parts of the boom.

2. The method according to claim 1 comprising mounting the carriage to the boom prior to maintenance work being carried out and removing the carriage once maintenance work is complete.

3. The method according to claim 1 wherein the carriage is permanently mounted to the boom.

4. The method according to claim 1 wherein the carriage is supported on the boom via wheels, the method including adjusting the position of the wheels on the carriage to accommodate variations in the shape of the boom and/or appurtenances on the boom, as the carriage moves along the boom.

5. The method according to claim 1 wherein the carriage comprises a framework adapted to be assembled into a box configuration with open ends, the method including the step of assembling the carriage to the boom such that the framework extends adjacent top, bottom and side faces of the boom.

6. A crane having a boom fitted with a movable carriage, wherein the carriage comprises a solid platform for bearing the weight of at least one person to allow access to the boom.

7. The crane according to claim 6 wherein the carriage is fitted with wheels which engage with the boom and whose position is adjustable to accommodate changes in the geometry of the boom and/or appurtenances on the boom, as the carriage moves along the boom.

8. The crane according to claim 6 wherein the carriage comprises a framework extending adjacent top, bottom and side faces of the boom.

9. A carriage for permitting access to a crane boom, the carriage comprising a framework capable of being assembled into a box configuration with open ends, the carriage further comprising:
wheels internal of the box framework for engaging with the crane boom;
a solid platform for supporting at least one person.

10. The carriage according to claim 9 wherein the position of the wheels is adjustable to accommodate changes in the geometry of the boom and/or appurtenances on the boom.

11. A crane having a boom fitted with a maintenance access carriage which is movable along the boom, the carriage comprising a framework surrounding the boom and a solid platform which is capable of supporting the weight of at least one person standing on the platform.
